(19) United States
(12) Patent Application Publication
(10) Pub. No.: US 2018/0094448 A1
(43) Pub. Date: Apr. 5, 2018

(54) SHADE GENERATOR

(71) Applicant: WALTER H. DAVIS, HARRISBURG, NC (US)

(72) Inventor: WALTER H. DAVIS, HARRISBURG, NC (US)

(21) Appl. No.: 15/724,560

(22) Filed: Oct. 4, 2017

Related U.S. Application Data
(60) Provisional application No. 62/404,469, filed on Oct. 5, 2016.

(51) Int. Cl. E04H 15/06

(52) U.S. Cl. CPC E04H 15/06; H02S 20/30

(57) ABSTRACT

An improved method and apparatus for creating shade over a designated area by providing a shade generator utilizing a combination computer-controlled drone and associated kite-canopy. The invented apparatus for creating shade may be movable, and may be adapted to provide solar power for its operation.

### CROSS REFERENCE TO RELATED APPLICATION

This application claims the benefit of priority of U.S. Provisional Patent Application Ser. No. 62/404,469, filed Oct. 5, 2016.

### FIELD OF THE INVENTION

The present invention relates to a hybrid kite apparatus for generating an area of shade, and more particularly to a drone-guided kite-like canopy, to produce shade.

### BACKGROUND OF THE INVENTION

It is desirable to have shade from direct rays of the sun in many places, such as for construction sites, sporting events, parties and other gatherings. Unfortunately, the only shade currently available other than from trees or buildings, is from tents, awnings, and ground-mounted canopies. These are limited in size and are also limited in the locations at which they can be used.

### SUMMARY OF THE INVENTION

The invention provides apparatus for creating a desired area of shade by use of an unmanned aerial vehicle (UAV), commonly known as a drone, with an associated canopy of kite material supported by the drone. The canopy may include solar panels for powering the drone. A tethering apparatus may also be provided to assist in maintaining the canopy and thus the shade in the desired position, for stability of the shade generator, and to avoid the necessity of complying with free-flying drone regulations.

The present invention is particularly useful at construction sites where it is advantageous to operate in the shade, and at sporting events, especially for spectators. The invention also has military uses, such as providing camouflage for large or small areas, and providing movable camouflage that can travel with and provide camouflage for convoys of vehicles, ships or other mobile items. In addition, its use over buildings can lower cooling costs and extend both paint life and shingle life on building exteriors.

### OBJECTS OF THE INVENTION

The principal object of the present invention is to provide an improved method of creating shade over a designated area.

Another object of this invention is to provide a shade generating canopy utilizing a combination drone and kite.

Another object of the invention is to provide apparatus for creating shade which will collect solar energy and provide power for its operation.

It is also an object of the invention to provide a shade generator that will create a movable shadow, the location of which is controllable.

### BRIEF DESCRIPTION OF THE DRAWINGS

The foregoing and other objects will become more readily apparent by referring to the following detailed description and the appended drawings in which:

FIG. 1 is a schematic diagram showing a preferred embodiment of the shade generating invention.

FIG. 2 is a schematic diagram showing relational connections of the parts of the shade generator.

### DETAILED DESCRIPTION

Referring now to the drawings, the invented shade generator apparatus 10 includes a canopy or kite 12, made of light weight fabric, a main drone control unit 14 and at least three drone units 16 remote from and connected electrically to the control unit 14 such as by wires 16 or it can be wireless. The drones 16 have propulsion means 20, such as propellers. The canopy 12 is connected to the drones 16 and provides shade from the sun S to the area beneath the canopy fabric.

A tether 24 may connect the shade generator apparatus 10 to a movable tether base 26, which may be powered by a battery 28 or by solar panels 30. To keep the base from lifting off the ground, it may be weighted with weights 32, such as heavy metal plates, as desired, and may be provided with wheels 34, which preferably may have brakes, not shown. The fabric of canopy 12 may be fastened to a frame 40, segments of which may be extensible. As noted above, the apparatus 10 is advantageously tethered for stability, and to avoid the requirement of complying with free-flying drone regulations. The battery 28 or solar panels 30 may provide the necessary power for operating the drone control unit 14 and drones 16, as well as related electronic equipment.

The power supply for the drones is advantageously, but not necessarily, provided by batteries, preferably lithium-polymer batteries. The computer control unit 14 of the drones 16 is preferably a microcontroller unit (MCU).

The area of shade beneath the kite canopy may be monitored by camera 50, or a heat sensor 50, whereby whenever the camera detects reflected sunlight, or the heat sensor detects radiated heat from the area that is supposed to be shielded, a signal is generated by the camera or the heat sensor to the microcontroller 14 to cause the drones to adjust the position of the canopy to create shade over the desired area and reduce the radiated heat or the reflected light, as the case may be.

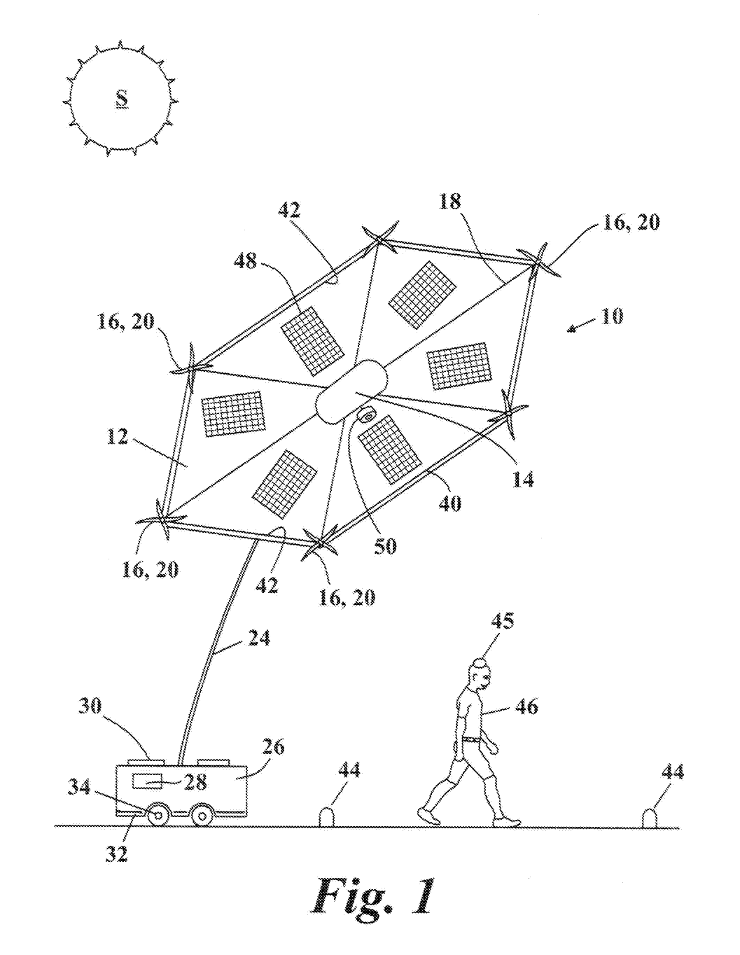

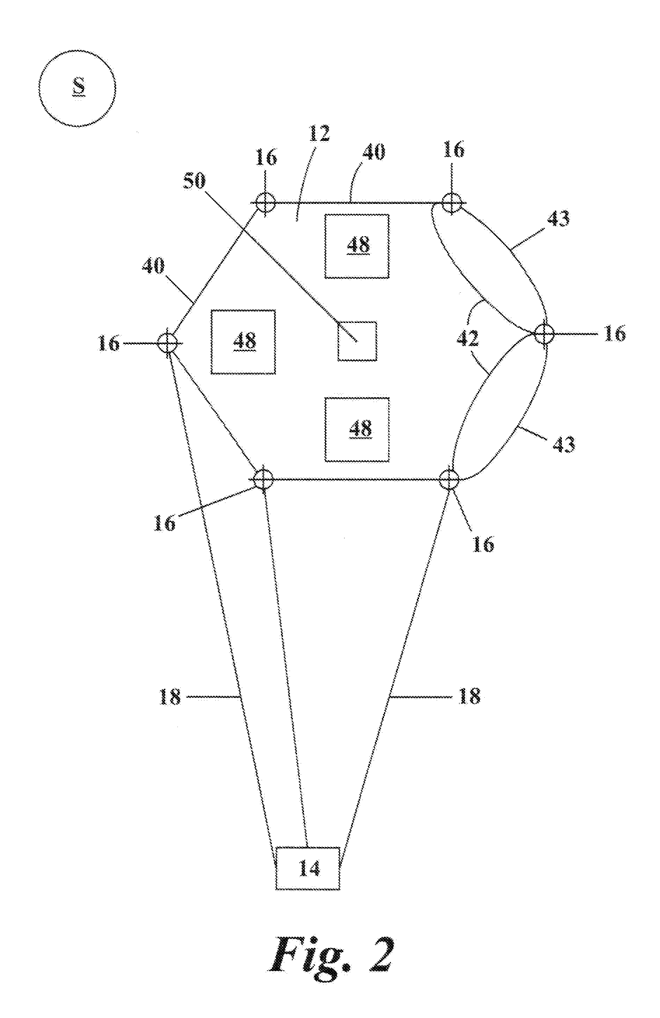

Alternatively, stationary sensors 44 may be positioned on the ground in desired locations to define the area to be shaded, and to communicate with the drone control unit 14 to maintain the canopy shade generator in the proper location. A movable sensor 45 may be affixed to or associated with a movable object, such as person 45 shown in FIG. 1, or another movable object such as a robot, which will control the location of the kite 12 or canopy and its shade. Camera 50 may be programmed to follow a specific moveable object with or without requiring a sensor. The stationary or movable sensor 44, 45 is a feedback sensor positioned on the ground or movable object, which acts as a positioning recorder around the desired area to be shaded. Camera 50 may be mounted on the drone control unit 14 of FIG. 1 or the kite fabric of FIG. 2 to visually verify the location of objects or people with respect to the shaded area size and location.

The drones 16 are computer controlled and guided by drone control unit 14, and are attached to the canopy 12 or kite frame 40, with a sufficient number of drones 16 or propellers 20 around the canopy or frame edges, to maintain sufficient canopy height and angle to produce the desired shade dimensions and location to cover a pre-determined area.

Advantageously, solar panels 48 may be positioned on the canopy upper surface to collect solar power for operating the invented apparatus, and are electrically connected to the drone controller unit 14 to deliver power thereto.

As shown in the Figures, an outer seam 42 in the fabric of canopy 12 can be provided to form a pocket 43 for air or gas in the outer seam to provide for rigidity of the kite fabric.

By mounting canopy 12 on a frame 40, it may be possible to utilize a single drone to control the canopy location rather than multiple drones.

### SUMMARY OF THE ACHIEVEMENT OF THE OBJECTS OF THE INVENTION

From the foregoing, it is readily apparent that I have invented an improved method and apparatus for creating shade over a designated area by providing a shade generator utilizing a combination drone and kite with a drone controller, as well as providing power for its operation.

It is to be understood that the foregoing description and specific embodiments are merely illustrative of the best mode of the invention and the principles thereof, and that various modifications and additions may be made to the apparatus by those skilled in the art, without departing from the spirit and scope of this invention.

What is claimed is:

1. An apparatus for generating shade for a designated area, comprising:
a controller;
at least three drones electronically connected to said controller;
a canopy of light weight kite fabric connected to said drones, which canopy provides shade from the sun to an area beneath said fabric.

2. An apparatus according to claim 1, further comprising an earth-bound base and a tether connecting said shade generator apparatus to said base to maintain said shade generator in a desired location.

3. An apparatus according to claim 1, further comprising a frame to which said kite fabric is fastened.

4. An apparatus according to claim 1, wherein said controller is a computerized microcontroller unit.

5. An apparatus according to claim 1, further comprising one or more sensors located remote from said apparatus to provide positioning information to said controller.

6. An apparatus according to claim 1, further comprising a camera associated with said controller, said camera being adapted to generate a signal to the controller to cause the drones to adjust the position of the canopy to create or maintain shade over a desired area.

7. An apparatus according to claim 1, further comprising a heat sensor associated with said controller, said heat sensor being adapted to generate a signal to the controller to cause the drones to adjust the position of the canopy to create or maintain shade over a desired area.

8. An apparatus according to claim 1, further comprising solar panels positioned on the upper surface of said canopy to collect solar power for operating said controller and said drones, said panels being electrically connected to said controller and to said drones.

9. An apparatus according to claim 2 wherein said base is movable.

10. A method of generating shade over designated area, comprising:
providing a computer-controlled drone having remote propeller units connected electronically to said drone;
providing a light weight fabric-covered kite connected to said drone;
providing a controller unit connected to said drone; and
activating said controller unit to move the kite into a position which provides shade from the sun to the area beneath said kite.

11. A method according to claim 10, further comprising providing a camera electronically connected to said drone, whereby said camera generates a signal to said drone indicating the area to be shaded, and said drone reacts by positioning or repositioning said kite to maintain the shaded area in a desired position.

12. A method according to claim 10, further comprising providing a heat sensor electronically connected to said drone, whereby said heat sensor generates a signal to said drone indicating the area to be shaded, and said drone reacts by positioning or repositioning said kite to maintain the shaded area in a desired position.
